(19) United States
(12) Patent Application Publication
(10) Pub. No.: US 2012/0100516 A1
(43) Pub. Date: Apr. 26, 2012

(54) PORTABLE PRACTICE TOOL FOR HEART MASSAGING IN CARDIOPULMONARY RESUSCITATION

(75) Inventors: Taku Iwami, Kyoto-shi (JP); Shin Nishina, Ikeda-shi (JP); Masaya Kawamura, Ikoma-gun (JP); Keiji Tomita, Iyo-shi (JP); Tomoko Tomita, Ehime (JP)

(73) Assignee: KYOTO UNIVERSITY, Kyoto-shi, Kyoto (JP)

(21) Appl. No.: 13/379,215

(22) PCT Filed: Jun. 16, 2010
(86) PCT No.: PCT/JP2010/060164

§ 371 Date: Dec. 19, 2011

(30) Foreign Application Priority Data
Jun. 19, 2009 (JP) 2009-147021

(51) Int. Cl. G09B 23/28

(52) U.S. Cl. 434/265

(57) ABSTRACT

Provided is a training box that is a practice tool for learning heart massaging (sternal compression) through experience; is low-cost, small-sized, light weight, and easy to transport; retains durability under repeated use; and on which AED use procedures can also be drilled. The portable practice tool for heart massaging in cardiopulmonary resuscitation is characterized by being provided with a chest-mockup main unit (1) having a thickness that is thicker than a thickness equivalent to the depth of chest cavity subsidence required during heart massaging (sternal compression), in which a palm-sized opening (3) in the center of the chest-mockup main unit (1) is opened in a vertical direction; a closed-cell synthetic resin foam (6a), which is covered by a bag (6d), contracts and expands in a vertical direction, and has a cavity (7) in the interior, is provided in said opening as a pressing part (6) that is moveable in the vertical direction; and a valve (8), which is for both the entrance and exit of air to the abovementioned cavity (7) and the detection thereof, is disposed on a side of the bag (6d).

### TECHNICAL FIELD

The present invention relates to a portable practical tool for training for cardiac massage (sternal compression) in cardiopulmonary resuscitation and is particularly used instead of a training doll that is a conventional practical tool. Therefore, the present invention relates to a portable practical tool that has a simple structure excellent in durability, that is inexpensive as compare to a conventional training doll, that is easily handled by common people including junior high-school and high-school students, that enables a practice of cardiac resuscitation to be started in a short time, that has a structure easily stored after the practice, and that enables efficient training for cardiac massage in cardiopulmonary resuscitation.

### BACKGROUND ART

Cardiopulmonary resuscitation is an emergency life-saving measure for cardiac arrest abbreviated as CPR. If heart beat completely stops, the brain is irreversibly damaged in three to five minutes, resulting in death; therefore, the principle of the cardiopulmonary resuscitation is to immediately take measures; and it is considered that blood circulation must be restarted and maintained to achieve a blood flow to the brain while dealing with stoppage of breathing, which occurs at the same time. Therefore, in the measures taken in the case of cardiac arrest, it is considered that cardiac massage must be performed to maintain the blood flow from the heart by compressing the heart while artificial respiration is given at the same time. Since not only healthcare professionals but also the general public may encounter a situation where the cardiopulmonary resuscitation must be performed on site, it is desired to give training and education of the right procedure widely to the public.

Conventionally, a cardiopulmonary resuscitation training doll used for training and education of the cardiopulmonary resuscitation is a full-fledged, highly-functional, expensive doll and large in size and, therefore, it is often physically difficult to prepare and store a multiplicity of dolls. As a result, an opportunity to give practical training for the cardiopulmonary resuscitation using the training dolls is inevitably restrained in real life. Under such circumstances, an automatically inflating doll has recently been developed and used on the assumption that one person uses one doll. However, a chest portion main body of the automatically inflating doll may burst after using several times, having a durability problem. A price of one doll set is expensive for assigning one doll to one trainee and, since the doll is assumed to be used by one individual and cannot be reused by a plurality of persons, this is still a cause that prevents the spread of the cardiopulmonary resuscitation training.

Since the automatically inflating doll is first three-dimensionally inflated like a human body by flowing air from a tube into a mannequin type human model and is plugged to complete the preparation for a practice, a time is required before starting the practice. After these preparations are completed, a trainee first lifts up the chin of a face portion of the model to tilt the head backward so that an airway is established, and pinches the nose and covers the mouse of the model with his/her mouse to blow in an amount of exhaled air for one second such that the chest is lifted up. Subsequently, the practice is performed by putting the heel of a palm of a hand on the center of the chest, covering the hand with the other hand with elbows straightened, and compressing the chest from above to below at the rate of 100 times per minute by 4 to 5 cm such that the chest returns to the original position after the compression. For storage in a box after the use, the air mast be discharged, and the storage must be performed with consideration for hygiene. As a result, the doll is unsuitable for the use in the field of education where preparation/practice/cleanup must be performed in a short time because of the time constraint.

Although it is desirable that the doll is stain-resistant and easily handled from the aspect of good hygiene for repeated use, a mock pad of AED (automated external defibrillator), for example, is used after an adhesive seal is peeled off from a mount and, if the pad is repeatedly used, the adhesive seal portion is soiled with hair and dirt and, therefore, the pad must effectively be discarded and replaced.

A typical cardiopulmonary resuscitation practical tool consisting of a head portion and a chest portion for training for cardiopulmonary resuscitation previously applied for a patent includes a resuscitation training human model consisting of an apparatus having an inflatable chest portion main body, which has a chest portion plate that distributes a pressure, a face mask in a head portion, and a lung portion of the chest portion connected to a mouse of the face mask (see, e.g., Patent Document 1). Since this is relatively smaller in size as compared to a conventional human model, lower cost may possibly be realized by mass production. However, since the preliminary work of blowing in air for inflation must be performed before use and it takes an effort of cleaning and wiping to deflate the human model from the aspect of hygiene after use, a time is required before and after a practice time in addition to the practice time. Therefore, even if one model can be prepared for each person because of a lower price, since cleaning and wiping are required after a practice, the structure is not based on the premise of repeated use by an unspecified number of people, and it is essential to prepare the human models to the number of participants in a training session etc. For example, if participants are changed three times in a training session, three sets must be prepared instead of using one set three times, i.e., one human model must be prepared for each of all the participants.

A system is also developed that controls a pneumatic pressure function in a patient simulator of a mannequin used in healthcare education and training (see, e.g., Patent Document 2). However, such a practical tool or training system is expensive and is not necessarily suitable for assigning one device to each trainee. Although other various devices are developed and applied for a patent, since all these devices consist of a cardiopulmonary resuscitation practical tool including a head portion and a chest portion and a part of a compression apparatus for cardiac massage in the chest portion has a complicated mechanical mechanism and therefore inevitably becomes extremely expensive, these devices are not sufficient for assigning one device to each trainee. Since an actual object is realistically reproduced, the apparatuses must be increased in thickness and size and therefore cannot possibly be made compact.

### PRIOR ART DOCUMENTS

### Patent Documents

Patent Document 1: Japanese Laid-open Patent Application Publication No. JP2006-526172A
Patent Document 2: Japanese Laid-open Patent Application Publication No. JP2007-507745A

### SUMMARY OF THE INVENTION

### Problem to Be Solved by the Invention

The cardiopulmonary resuscitation includes a basic life support performed on site and an advanced life support performed by using various devices or medicaments in a hospital etc. The basic life support performed on site includes establishment of airway, artificial respiration, and cardiac massage (also referred to as sternal compression) of a patient with cardiopulmonary arrest. In the basic life support, ordinary persons near a patient with cardiopulmonary arrest perform the life support of artificial respiration and cardiac massage as soon as possible and, if heart beat stops, starting a resuscitative measure within three to five minutes is considered as a target for resuscitation without giving damage to the brain. However, for this purpose, it is desired and requested that the general public widely practices the basic life support on a routine basis. Therefore, the Fire and Disaster Management Agency, an external bureau of the Ministry of Internal Affairs and Communications in Japan, publishes the cardiopulmonary resuscitation and the usage of AED (automated external defibrillator) as a flow of the life support in the form of the procedure of the cardiopulmonary resuscitation and the usage procedure of AED, and the announcement is widely made.

As described in the background, since a training device for practicing the procedure of cardiopulmonary resuscitation is generally expensive and it is difficult to give one device to each of many trainees, the device is unsuitable for allowing the general public to easily practice the cardiopulmonary resuscitation. Although the cardiopulmonary resuscitation is generally a method consisting of a combination of chest compression and artificial respiration, the artificial respiration requires the learning of the procedure, and although when one person attempts the cardiopulmonary resuscitation, the person must perform artificial respiration while minimizing interruption of the chest compression, if the person hesitates to give artificial respiration because of lack of practice when attempting the cardiopulmonary resuscitation consisting of a combination of the chest compression and the artificial respiration, a negative side due to the interruption of the chest compression adversely becomes prominent, and the effect of the cardiopulmonary resuscitation may be reduced if appropriate artificial respiration cannot be performed.

In this regard, in April 2008, American Heart Association has issued an emergency statement that the cardiopulmonary resuscitation consisting of chest compression only is positively recommended if performed by an untrained person or a trained person having no confidence. This emergency statement has been issued in response to the report that an effect of improving an outcome from a cardiopulmonary arrest state is acquired even if only the chest compression is sufficiently and accurately performed rather than interrupting the chest compression due to unaccustomed and insufficient artificial respiration.

Therefore, assuming that the establishment of airway and the artificial respiration can separately be practiced, it is a problem to be solved by the present invention to provide a training box that is small in size and space-saving as inexpensive as possible, that has a lighter weight and a compact thickness enabling easy transportation, and that is durable and repeatedly usable, as a practical tool for correctly learning a procedure of cardiac massage (sternal compression), and to provide the training box that also enables training for the usage procedure AED (automated external defibrillator), which is often utilized subsequently to the cardiac massage.

### Means for Solving the Problem

A means of the present invention for solving the problem in an aspect of the invention of claim 1 is a portable practical tool for cardiac massage in cardiopulmonary resuscitation, the practical tool having a chest-mockup main unit thicker than a thickness corresponding to a chest portion depression depth required for cardiac massage (Sternal compression), the chest-mockup main unit being made of foam synthetic resin, the chest-mockup main unit having a palm-sized through-hole imitating a size of a chest compression site from a top surface to a bottom surface in a center portion, the practical tool being disposed with a closed-cell synthetic resin foam that has an air chamber inside contracted and returned in the top/bottom surface direction, the closed-cell synthetic resin foam being covered with a bag made of a synthetic resin film, the bag being disposed with a valve in a side portion, the valve being used both for entrance/exit of air in the air chamber and for detection thereof, the closed-cell synthetic resin foam disposed with the air chamber inside and covered with the bag being disposed in the through-hole as a pressing unit for cardiac massage practice, the practical tool having a gap between the through-hole and the pressing unit so as to allow free up-and-down movement of the pressing unit.

An aspect of the invention of claim 2 provides the portable practical tool for cardiac massage in cardiopulmonary resuscitation of claim 1, wherein the thickness corresponding to the chest portion depression depth required for cardiac massage (sternal compression) is 5 to 25 mm, and wherein the chest-mockup main unit is made of a foam synthetic resin thicker than the thickness and having an outer shape of a rectangular parallelepiped.

An aspect of the invention of claim 3 provides the portable practical tool for cardiac massage in cardiopulmonary resuscitation of claim 1 or 2, wherein the top surface of the chest-mockup main unit is covered with a synthetic resin film except a portion of the top surface of the palm-sized through-hole.

If the thick chest portion of human body is simply reproduced without changing the strength thereof as in a conventional case so as to enable a trainee to feel a force of pressing down an area around the breastbone about 5 cm, a thickness greater than the depression amount to be pressed is required in an apparatus as a whole and, therefore, the overall thickness and structure becomes complicated, making storage difficult; in contrast, in the present invention, even without actual depression of 50 mm considered as the chest portion depression depth required for the chest depression, the pressing unit of the closed-cell synthetic resin foam having the air chamber inside can make a corresponding depth for learning the solid feel and the application of weight at the time of the pressing shallower than the actual depth; and therefore, the overall thickness of the apparatus can be made thinner as compared to the reproduction of an actual object. Whether an appropriate feeling at the time of pressing is acquired may easily be comprehended by the valve that detects entrance/exit of air in the air chamber of the bag of the pressing unit.

In other words, when the pressing unit is pressed by hands, the synthetic resin foam in the bag is contracted, and the air in the inside air chamber is pushed out and discharged from the valve for air entrance/exit and air entrance/exit detection. The air chamber inside the synthetic resin foam in the bag is a cavity communicating with the outside of the synthetic resin foam, and air may enter/exit from the valve on the side portion of the bag through a groove, a slit, or a discharge hole leading from the cavity to an outer wall of the synthetic resin foam.

If a thickness corresponding to the chest portion depression depth required for chest compression is set to 5 to 25 mm, the feeling of pressing down the chest of human body by 5 cm can be acquired by pressing-down of this thickness and, therefore, the overall thickness of the apparatus can be made thinner as compared to the reproduction of an actual object. Since the chest-mockup main unit is made of the synthetic foam resin having an outer shape of a simple rectangular parallelepiped, the troubles of transportation and assembly are saved and convenience is enhanced by easier storage, the space-saving nature, etc.

If the top surface of the chest-mockup main unit is covered by the synthetic resin film except a portion of the top surface of the palm-sized through hole, the top surface is less stained, and finger marks etc., can easily be cleaned by wiping out and, therefore, the device can repeatedly be used for the practice by a multiplicity of persons. When practicing the placement of AED pads, the bodily sensation at the time of practice is enhanced due to the feeling of adherence of the pads.

An aspect of the invention of claim 4 provides the portable practical tool for cardiac massage in cardiopulmonary resuscitation of any one of claims 1 to 3, wherein the closed-cell synthetic resin foam (6a) covered with the bag (6d) and having the air chamber (7) inside contracted and returned in the top/bottom surface direction is a double-tier two-layer foam, and wherein the foam is formed as the double-tier two-layer foam by stacking a rubber-like elastic closed-cell synthetic resin foam (6b) having an opening hole in the vertical direction in the center portion, and a rubber-like elastic closed-cell synthetic resin foam (6c) having a greater elastic modulus and a concentric opening hole with a diameter greater than the opening hole in a center portion.

For example, the pressing unit for practicing cardiac massage has a size of a palm, for example, a diameter of about 100 to 120 mm and formed by housing the closed-cell synthetic resin foam compressible from the top/down surfaces and having the air chamber inside, into the bag made of an airtight-structure synthetic resin film, for example, an airtight-structure flexible polyvinyl chloride film. This closed-cell synthetic resin foam is two-layer foam formed by stacking rubber-like elastic closed-cell synthetic resin foams having different elastic moduli in two tiers.

The closed-cell synthetic resin foam used in the present invention is a foam having a small compression set and a rebound resilience, and can be exemplarily illustrated by thermoplastic elastomer foam, rubber foam, etc., such as closed-cell polyethylene foam, polyolefin foam, polyurethane foam, styrene-butadiene resin (SBS), ethylene-vinyl acetate copolymer (EVA) resin, or blend-type resin such as PE/EVA or PE/EEA.

Assuming that the thickness of the chest-mockup main unit is 50 mm, the closed-cell synthetic resin foam of a first tier is a closed-cell polyethylene foam having three-fifths of the thickness, i.e., a thickness of 30 mm and has the opening hole in the vertical direction in the center portion. The opening hole in the center portion has a diameter of 20 mm, for example. The closed-cell synthetic resin foam of a second tier is a rubber-like elastic closed-cell synthetic resin foam having a greater elastic modulus than the closed-cell synthetic resin foam of the first tier and has the opening hole concentric to the above opening hole and having a greater diameter, for example, the opening hole of 40 mm, in the center portion, and is made of a closed-cell polyolefin foam having two-fifths of the thickness, i.e., 20 mm when the thickness of the chest-mockup main unit is assumed as 50 mm.

Since the two layers of the closed-cell synthetic resin foam stacked in two tiers respectively have the concentric opening holes in the center and the opening holes act as the air chamber, if the opening holes are pressed, a wind pressure is detected that passes through the valve disposed on the side portion of the bag for air entrance/exit and air entrance/exit detection in the bag, and a whistle emitting sound is blown.

Since a difference in elastic modulus of rubber-like elasticity is provided between the first and second tiers of the double-tier two-layer foam, vertical inversion of the pressing unit may add a sensory difference in hardness transmitted to the hand at the time of pressing. For example, while the firm feeling of the chest portion is transmitted to the hand by disposing a firm hardly-recessed closed-cell foam having a smaller elastic modulus of rubber-like elasticity on the upper layer side, a soft resilient closed-cell foam having a larger elastic modulus of rubber-like elasticity is disposed on the lower layer side such that the rear surface side is first contracted when being pressed down and the firmly pressing feeling may be actually be felt. At the time of use, the foam can differently be used depending on a purpose by interchanging the positions of the first tier and the second tier to give priority to comprehension of positions or to feel an accurate depression depth.

Since the opening hole of the air chamber disposed in the layer of the foam having a larger elastic modulus is greater than the opening hole of the air chamber disposed in the layer of the foam having a smaller elastic modulus, air can more efficiently be pushed out at the time of compression. The foam of the pressing unit may be disposed with a groove, a slit, a discharge hole, etc., from the opening hole in the center portion toward the outer circumference and, as a result, the air is more smoothly discharged from the opening hole acting as the air chamber.

An aspect of the invention of claim 5 provides the portable practical tool for cardiac massage in cardiopulmonary resuscitation of any one of claims 1 to 4, wherein the valve for air entrance/exit and air entrance/exit detection in the bag disposed on the side portion of the bag emits a sound depending on a wind pressure.

Since the valve for air entrance/exit detection is formed as a whistle emitting a sound depending on a wind pressure, the whistle is not properly blown unless not only a pressing amount but also a sufficient pressing speed is associated, and a trainee can recognize that only pressing gradually and slowly is insufficient depending on the presence of the emission of a sound. Therefore, it can easily be checked and comprehended whether a degree of applied force and control of a pressing speed required for chest compression are accurate at the time of pressing.

An aspect of the invention of claim 6 provides the portable practical tool for cardiac massage in cardiopulmonary resuscitation of any one of claims 1 to 5, wherein the chest-mockup main unit is made of a colored synthetic resin foam, and wherein the closed-cell synthetic resin foam covered with the bag and having the air chamber inside contracted and returned in the top/bottom surface direction is made up of two layers of foam stacked in two tiers respectively colored differently from the chest-mockup main unit.

For example, between the two layers of foam vertically stacked in two tiers, the rubber-like elastic closed-cell foam of the upper layer is made of a closed-cell polyethylene foam having three-fifths of the thickness of the typical chest portion and is colored in red-orange; the rubber-like elastic closed-cell foam of the lower layer is made of a closed-cell polyolefin foam having two-fifths of the thickness of the typical chest portion and is colored in pink; and, as a result, the two layers are configured such that when the orientation of the upper and lower layers is inverted, a trainee can easily comprehend the orientation from the colors. The color of the typical chest portion is differentiated by pale flesh color and the position of the pressing unit is visually easily recognized. The two upper and lower layers of the foam have different rubber-like elastic forces and, therefore, the vertical inversion of the bag of the pressing unit changes the feeling of hardness transmitted to the hand at the time of pressing and, even if not pressing, one of the vertical orientations may visually be comprehended.

Additionally, the different colors of the two upper and lower layers of the closed-cell foam enable beginners to easily comprehend the pressing unit for cardiac massage practice and, since the double-stacked upper and lower tiers of the pressing unit for cardiac massage practice are differently colored to enable visual recognition, even if the double-tier foam is vertically inverted, the difference in vertical orientation is easily visually recognizable based on the coloring. For example, in such a case that the practice is performed by a person with a weaker pressing force such as an elementary school student or a woman, even if the correct position is pressed, no sound may be emitted from the whistle because of the weaker pressing force of such a person, and the educational effect may not sufficiently be acquired in terms of comprehension of the pressing position of chest compression. In this case, the vertical orientation can be checked by color to invert the vertical orientation of the upper and lower tiers and, therefore, it can easily be instructed to vertically invert the pressing unit for the cardiac massage practice to the orientation allowing a weaker pressing force to generate a sound such that the practice can appropriately be performed. As a result, the practice can be performed in the orientation allowing a weaker pressing force to generate a sound and, therefore, the pressing at a correct position with a correct posture can first be comprehended in a sensory manner. In this way, the educational effect in the cardiac massage practice can be acquired through the comprehension of the position. Subsequently, by inverting the vertical orientation of the double-tier foam again to the original vertical orientation of color, what degree of pressing force is actually required and the depression depth required for the sternal compression can easily be comprehended by pressing until a sound is emitted and, therefore, the correct teaching can be given by facilitating the visual comprehension with color and learning is made easier.

An aspect of the invention of claim 7 provides the portable practical tool for cardiac massage in cardiopulmonary resuscitation of any one of claims 1 to 6, wherein the portable practical tool further has a box including a single-hinged lid capable of housing the chest-mockup main unit, wherein the single-hinged lid of the box is connected to one side-wall upper end of the box in a freely openable and closable manner, and wherein a head portion, a neck portion, and a shoulder portion of a human model are drawn on an inner surface of the opened lid and linked to the chest-mockup main unit housed in the box.

Since the portable practical tool for cardiac massage in cardiopulmonary resuscitation of the means of the present invention is housed in the box with the head portion and the neck portion of the human model drawn inside the lid, the upper side from the chest portion of the human model can immediately visually appear when the lid of the box is opened on a practice site and, therefore, it takes no time to assemble the head portion and the appropriate chest compression site may more properly be comprehended, thereby realizing a cardiac massage practice with a higher sense of presence.

An aspect of the invention of claim 8 provides the portable practical tool for cardiac massage in cardiopulmonary resuscitation of any one of claims 1 to 7, wherein the portable practical tool is disposed with a mock AED imitating an operation surface shape of AED, i.e., automated external defibrillator, and two mock electrode pads in a pair made of synthetic resin sheets self-adhesive only on the back sides at ends of two codes extended from the mock AED, and wherein the two mock electrode pads are detachably placed on the top surface of the synthetic resin film covering the circumference of the rectangular parallelepiped of the chest-mockup main unit.

Since the portable practical tool for cardiac massage is disposed with the sheet of the mock AED having the two mock electrode pads in a pair, not only the cardiac massage practice but also a practice of the usage procedure such as correctly disposing electrodes and activating AED can easily be performed by the use thereof.

### EFFECTS OF THE INVENTION

Because of the means described above, first, the portable practical tool for cardiac massage in cardiopulmonary resuscitation of the present invention is excellent in portability since the thickness may not be the same as a real object and may be compact. Although the chest portion of a human body is imitated, the portable practical tool is simply configured, significantly inexpensive as compared to a human model for cardiac massage practice, more easily handled, and irrefrangible due to the simple configuration. Because of the covering by the synthetic resin film, the portable practical tool is less stained; stains are easily wiped out; the covering synthetic resin film is easily replaced; therefore, the portable practical tool is excellent in ensuring good hygiene if the device is repeatedly and sequentially used for the practice by a plurality of persons; and the practice of basic action of cardiac massage in cardiopulmonary resuscitation can easily and broadly be performed.

Second, the pressing unit for cardiac massage practice can vertically be inverted to change the strength of the pressing force. For example, the pressing unit can easily vertically be inverted and switched between a practice of the pressing force for an adult having a need for cardiopulmonary resuscitation and a practice of the pressing force for a child having a need for cardiopulmonary resuscitation, for example. For a sensor from which a pressing speed of cardiac massage in the correct posture is easily recognized, the valve emitting a whistle sound is particularly disposed as the sensor such that the accurate pressing speed of cardiac massage can be judged and, therefore, the cardiac massage practice can easily be performed at a proper speed in a correct posture. In other words, since the whistle is not sufficiently blown even when being pressed if the pressing speed of the pressing unit is too slow, the required pressing force and the pressing speed can very easily be sensed regardless of the simple configuration.

When the practice is repeated with the appropriate pressing speed, a trainee easily recognizes whether the pressing is repeated at an appropriate pace (100 times per minute) on the basis of the generated whistle sound, and a state of the practice is easily comprehended by a third person such as an instructor who supervises the practice at a short distance.

Third, since different colors are given to the major constituent units of the practical tool for cardiac massage, i.e., the chest-mockup main unit and the double-tier pressing unit for cardiac massage practice, anyone can rightly use the major units of the device to perform the practice.

Fourth, since the practical tool for cardiac massage in cardiopulmonary resuscitation is housed in the box with the upper lid and the head portion and the neck portion are schematically drawn on the opened lid inner surface and linked to the practical tool for cardiac massage in cardiopulmonary resuscitation imitating the chest portion within the box, the upper-body human model can immediately appear when the lid is simply opened, and can compactly be stored and carried after the completion of practice by closing the lid. Therefore, the position and shape of a human body subjected to cardiac massage can immediately be revealed and comprehended by opening the upper lid of the box housing the practical tool of cardiac massage, and the practical tool can immediately be put into a transportable state by simply closing the lid, without effort of inflation before use and deflation before storage as in the case of a conventional human model.

Fifth, since the practical tool for cardiac massage is accompanied by the AED mock sheet imitating AED and the electrode mock pads imitating electrodes self-adhesive only on the back sides, the practice of usage of an AED apparatus can repeatedly be performed. Because the electrode mock pads are self-adhesive only on the back sides, i.e., the typical electrode surfaces, the top side and the back side of the pads can easily be confirmed and, therefore, it can immediately be checked whether the top side and the back side of the pads are correctly located at the proper positions on the film surface of the chest-mockup main unit formed into a rectangular parallelepiped, thereby enabling a more practical practice to be repeated.

As described above, the present invention enables the practice of cardiac massage in cardiopulmonary resuscitation to be prepared easily in a short time, enables the practice with a sense of presence, facilitates storage and transfer because of lightweight and compact thickness, and is inexpensive so that the devices can be lent to a multiplicity of persons to perform the practice at one time and the device can repeatedly be used, thereby achieving unconventional excellent effects.

### BRIEF DESCRIPTION OF DRAWINGS

FIG. 1 is a perspective view of a box that houses a practical tool for cardiac massage in cardiopulmonary resuscitation of the present invention and AED that is an automated external defibrillator.

FIG. 2 is a plane view of the box that houses the practical tool for cardiac massage in cardiopulmonary resuscitation with the AED removed.

FIG. 3 is a plane view of an AED mock sheet that imitates AED and electrode mock pads that imitate electrodes.

FIG. 4 is a perspective view of assembly of a chest-mockup main unit formed into a rectangular parallelepiped of the practical tool for cardiac massage in cardiopulmonary resuscitation.

FIG. 5 is a perspective and plane view of a palm-sized pressing unit for cardiac massage practice, which is a closed-cell synthetic resin foam having an air chamber inside sealed by an airtight-structure synthetic resin film, for disposing in the chest-mockup main unit formed into a rectangular parallelepiped of the practical tool for cardiac massage in cardiopulmonary resuscitation.

FIG. 6 is a perspective view of how the chest-mockup main unit formed into a rectangular parallelepiped is housed into the box having a single-hinged lid.

FIG. 7 is a perspective view how the palm-sized pressing unit for cardiac massage practice is housed into the chest-mockup main unit housed in the box in FIG. 6.

FIG. 8 is a perspective view of a double-tier two-layer foam that is the palm-sized pressing unit for cardiac massage practice disposed in a palm-sized through-hole of the chest-mockup main unit formed into a rectangular parallelepiped housed in the box, (a) when a closed-cell synthetic resin foam having a smaller elastic modulus of rubber-like elasticity is the top surface and (b) when a closed-cell synthetic resin foam having a larger elastic modulus of rubber-like elasticity is the top surface.

FIG. 9 is a schematic of a side surface of the palm-sized pressing unit for cardiac massage practice and respective pressurized states of the pressing unit, (a) when the closed-cell synthetic resin foam having a smaller elastic modulus of rubber-like elasticity is the top surface and (b) when the closed-cell synthetic resin foam having a larger elastic modulus of rubber-like elasticity is the top surface, in respective compressed states.

### MODES FOR CARRYING OUT THE INVENTION

Embodiments of a practical tool for cardiac massage in cardiopulmonary resuscitation of the present invention will now be described with reference to the drawings.

A first embodiment of the practical tool for cardiac massage in cardiopulmonary resuscitation will be described. Assuming that a chest portion depression amount pressed down by sternal compression of cardiac massage is normally 50 mm, a corresponding pressing amount at the time of practice is set to 15 mm, for example, and a material of a pressing unit 6 has an elastic hardness that causes a pressing amount of 15 mm due to a corresponding pressing strength. The overall thickness of the pressing unit 6 is set to a thickness greater than the thickness of 15 mm of the corresponding pressing amount. In other words, the thickness of material of the pressing unit 6 for cardiac massage practice is set to a thickness, for example, 50 mm, which is greater than the thickness of depression, i.e., 15 mm.

A chest-mockup main unit 1 has an opening into which the pressing unit 6 is completely fit, and has the thickness same as the thickness of 50 mm of the material of the pressing unit 6 for cardiac massage. Therefore, the chest-mockup main unit 1 is formed as a rectangular parallelepiped having the thickness of 50 mm depicted in FIG. 4(b), for example, and upper and lower surfaces that are flat surfaces of a rectangular size of longitudinally 250 mm×laterally 320 mm, for example, corresponding to a chest portion area. The chest-mockup main unit 1 is made of a closed-cell synthetic resin foam 6a, for example, a polyethylene foam, having a hardness causing the pressing amount of about 10 mm. The closed-cell synthetic resin foam 6a of the chest-mockup main unit 1 may be other materials such as styrene foam.

Pressing down the chest-mockup main unit 1 itself is not the purpose of the training of chest compression. However, the chest-mockup main unit 1 may mistakenly be pressed down or a portion of the chest-mockup main unit 1 may be pressed down in accordance with the pressing of the pressing unit 6 for cardiac massage practice of chest compression. Therefore, the chest-mockup main unit 1 is desirably made of a lightweight material having a smaller elastic modulus that is almost not recessed because of a strength resistible to compression even when a certain degree of pressing force is applied and, for example, the closed-cell synthetic resin foam 6a of the chest-mockup main unit 1 is made of polyethylene foam and has an apparent density of 35 kg/m³ and a compressive hardness of 57 kPa.

A palm-sized through-hole 3 simulating a size of a chest compression site is disposed in a center portion 2 of the top and bottom surfaces of the chest-mockup main unit 1 formed into a rectangular parallelepiped. In this case, the palm-sized through-hole 3 is the heart-shaped through-hole 3 that simulates an image of the heart as depicted in FIG. 4, for example. It is obvious that the shape is not limited to the heart shape simulating an image of the heart as long as the through-hole is palm-sized and, for example, the through-hole may be in a palm-sized circular or square shape having a diameter of about 12 cm. In this case, except a portion of the palm-sized through-hole 3 in the top surface, the circumference of the chest-mockup main unit 1 formed into a rectangular parallelepiped is covered with a synthetic resin film 4, for example, a transparent flexible polyvinyl chloride film with a thickness of 0.2 mm, as depicted in FIG. 4(a). In this case, the top surface of the synthetic resin film 4 depicted in FIG. 4(a) is formed with a double polyvinyl chloride layer somewhat raised at left and right symmetric positions relative to the heart-shaped through-hole 3 simulating an image of the heard in the center portion to simulate left and right nipples 5 of a body such that the chest-mockup main unit 1 is visually achieved. As a result, the position of compression between the nipples may immediately and accurately be comprehended.

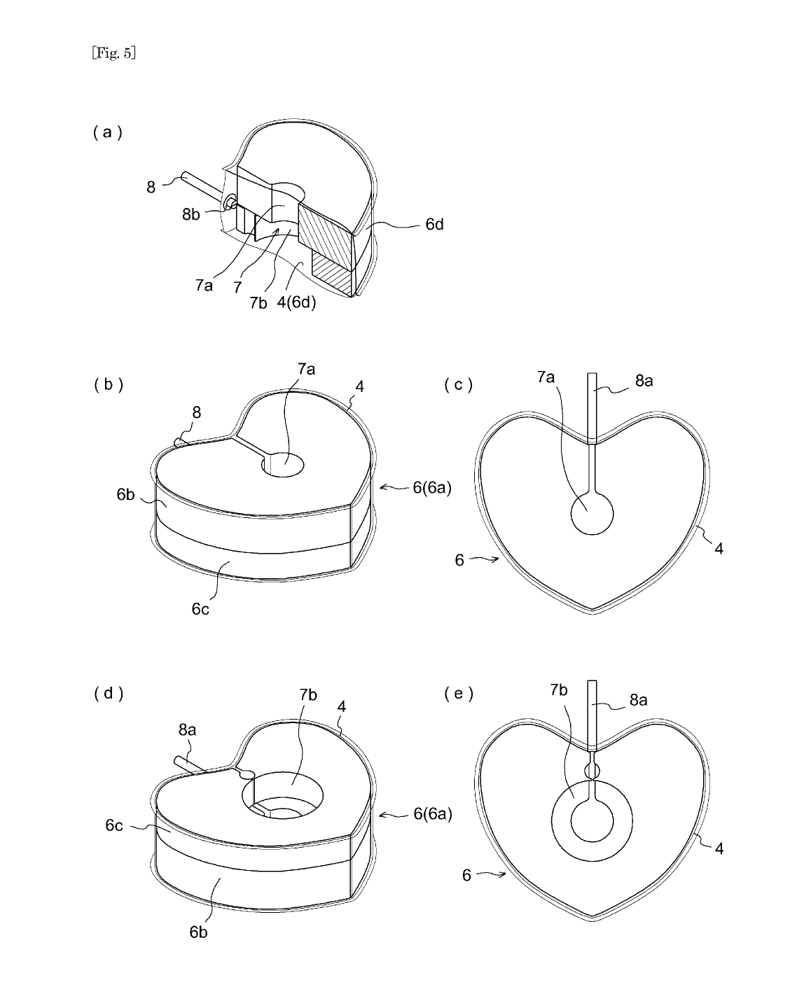

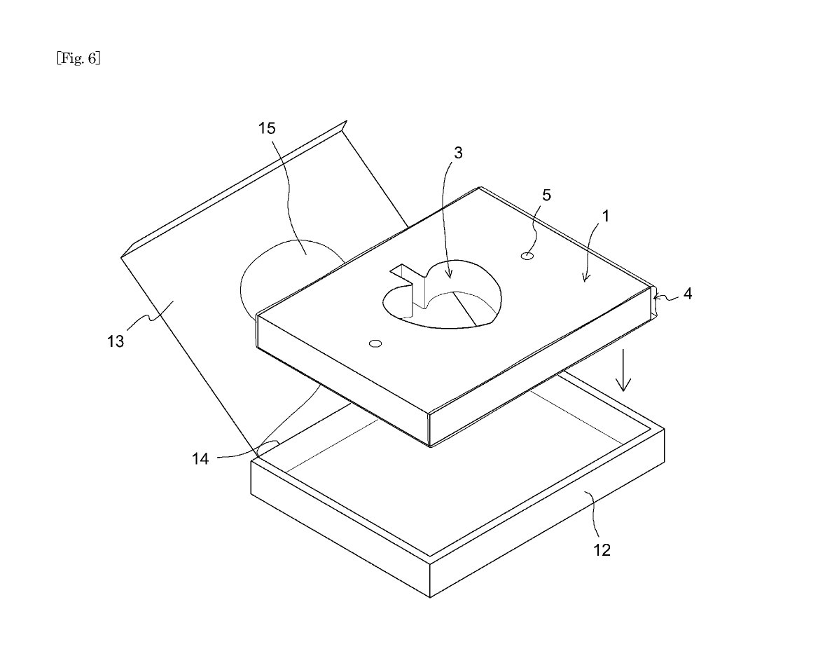

As depicted in FIG. 5, the closed-cell synthetic resin foam 6a compressible in the top/bottom surface direction and having an air chamber 7 inside is housed in a bag 6d of the airtight-structure synthetic resin film 4, for example, a transparent flexible polyvinyl chloride film. The closed-cell synthetic resin foam 6a is made up of a double-tier foam consisting of an upper-tier foam 6b and a lower-tier foam 6c, for example. A side portion of the bag 6d is disposed with a valve 8 for air entrance/exit and air entrance/exit detection in the bag 6d. For the detection of entrance/exit of air by the valve 8, the detection may be achieved by using a device such as a whistle 8a that emits a sound depending on air volume or air pressure or may be achieved by combining a sensor that detects air volume or air pressure with a mechanism (not depicted) that outputs information acquired by the sensor as light or electronic sound.

With regard to the transparent flexible polyvinyl chloride film used for the bag 6d that achieves the airtight structure around the closed-cell synthetic resin foam 6a of the pressing unit 6 for cardiac massage practice, the thickness is 0.3 mm, for example; a bottom-surface part, an top-flat-surface part, and a side belt-like part of the bag 6d are cut out and formed from a flexible polyvinyl chloride film in advance; and the side belt-like part is disposed with one opening portion 8b acting as an air entrance/exit with a diameter of 10 mm, for example. The opening portion 8b may be increased in thickness and strength in advance by overlapping and embossing a film of the same material with a diameter of 15 mm as needed. These flexible polyvinyl chloride films can be welded and jointed by, for example, a high-frequency welder to easily acquire the airtight structure.

The lower-tier foam 6c and the upper-tier foam 6b are stacked in this order on the bottom-surface flexible polyvinyl chloride film having a somewhat larger outer circumference; a loop of the side belt-like part formed by jointing the longitudinal ends of the film is put into a frame; and a folding margin portion of about 15 mm of the side belt-like part is folded outward to weld the bottom-surface part film and the side belt-like part film with the high-frequency welder. In the same way, the upper-flat-surface part film and the upper folding margin portion of the side belt-like part film are jointed and integrated to form the pressing unit 6 for cardiac massage practice in a size capable of being fitted into the palm-sized through-hole 3.

The pressing unit 6 for cardiac massage practice in a size capable of being fitted into the palm-sized through-hole 3 is fitted with a gap 3a between the chest-mockup main unit 1 and the pressing unit 6 for cardiac massage practice so as to be vertically contracted and returned without friction with a hole wall surface 3b of the palm-sized through-hole 3 opened in the center portion 2 in the top surface of the chest-mockup main unit 1, thereby forming the portable practical tool for cardiac massage in cardiopulmonary resuscitation.

A second embodiment of the present invention will hereinafter be described. First, the structure of the pressing unit 6 for cardiac massage practice will be described. The pressing unit 6 is housed in the bag 6d made of the airtight-structure synthetic resin film 4, for example, the airtight-structure 0.3-mm thick flexible polyvinyl chloride film. The pressing unit 6 is made up of the closed-cell synthetic resin foam 6a compressible from the top/down surfaces and having the air chamber 7 inside. The closed-cell synthetic resin foam 6a is made of a rubber-like elastic closed-cell foam. For example, assuming that the thickness of the chest-mockup main unit 1 is 50 mm, a thickness of 30 mm, i.e., three-fifths of the thickness is formed as the upper-tier foam 6b made of a closed-cell polyethylene foam; a vertically penetrating 20-mm diameter opening hole is provided as an upper cavity 7a in the center portion; and the pressing unit 6 is formed as a double-tier two-layer foam along with the lower-tier foam 6c made of a rubber-like elastic closed-cell synthetic resin foam having a larger elastic modulus, for example, a rubber-like elastic closed-cell polyolefin foam having a larger elastic modulus different from the upper-tier foam 6b made of the polyethylene foam and having two-fifths of the thickness of the chest-mockup main unit 1, i.e., a thickness of 20 mm, which is two-fifths of the 50-mm thickness. The lower-tier foam 6c is disposed with, for example, a vertically penetrating 40-mm diameter opening hole as a lower air chamber 7b in the center portion. A slit is formed in each of the upper-tier foam 6b and the lower-tier foam 6c by making a 2-mm width cutout from the opening hole in the center portion to the outer circumference. As a result, air from the upper air chamber 7a and the lower air chamber 7b is rapidly pushed out to the outside of the foams 6b, 6c at the time of pressing.

The upper-tier foam 6b is a closed-cell polyethylene foam having an apparent density of 65 kg/m³ and a 25% compressive hardness of 140 kPa, and the lower-tier foam 6c is a polyolefin foam having an apparent density of 54 kg/m³ and a 25% compressive hardness of 40 kPa. The lower tier is made of a material excellent in flexibility and elasticity as compared to the upper tier. The valve 8 for air entrance/exit and air entrance/exit detection in the bag 6d disposed on the side portion of the bag 6d is the whistle 8a that emits a sound depending on air pressure in the portable practical tool for cardiac massage in cardiopulmonary resuscitation.

The whistle 8a is made up of the whistle 8a that emits a sound from a pressure of discharged air when the rubber-elastic pressing unit 6 for cardiac massage practice is pressed, for example, 15 mm by applying a force from the top surface at one stroke. For example, the whistle 8a is, for example, a single-tone pitch pipe (structure with a thin piece of a free reed vibrating in a housing like a harmonica) and, as depicted in FIG. 5(a), the housing of the pitch pipe is inserted through the opening portion 8b in the side wall of the bag 6d of a flexible polyvinyl chloride film and is held airtight by the bag 6d of the synthetic resin film 4 made of a flexible polyvinyl chloride film.

When the whistle 8a like a pitch pipe is used in this way, an air volume and a wind pressure sufficient to vibrate the reed of the whistle 8a are required for generating a sound. Therefore, in the practice of the cardiac massage (sternal compression), the whistle 8a cannot properly be blown by the air discharge from the pressing unit 6 for cardiac massage practice unless not only a pressing amount but also a pressing speed is sufficiently associated, and only pressing gradually and slowly is insufficient for generating a sound. Therefore, a trainee can easily check and comprehend whether a degree of applied force and control of a pressing speed required for chest compression are accurate at the time of pressing. It takes a considerable effort to repeatedly and continuously press with a sound-emitting strength at a rate of 100 times per minute, which is considered as a normally required rate. As a result, it is predicted that a sound is likely to be interrupted along the way. Therefore, a trainee can also actually feel that it is difficult to perform cardiac massage alone while maintaining the correct strength for a long time.

Since a difference in elastic modulus of rubber-like elasticity is provided between the upper and lower layers of the double-tier two-layer foam, the pressing unit 6 for cardiac massage practice is formed such that the vertical inversion thereof may add a sensory difference in hardness transmitted to the hand at the time of pressing of the pressing unit 6 for cardiac massage practice by a palm of the hand. For example, while the firm feeling of the chest portion is transmitted to a palm of the hand by disposing a firm hardly-recessed upper-tier foam 6b on the upper layer side of two layers stacked in two tiers, the somewhat soft resilient lower-tier foam 6c is disposed on the lower layer side such that the rear surface side, i.e., the lower layer side is first contracted as depicted in FIG. 9(a) when being pressed down by a palm of the hand so as to actually feel the firmly pressing feeling with a palm of the hand.

FIG. 9 is a schematic of a side surface of the palm-sized pressing unit 6 for cardiac massage practice before and after pressurization in a somewhat exaggerated manner. In (a), the upper-tier foam 6b having a smaller elastic modulus of rubber-like elasticity is the top surface and, in (b), the pressing unit 6 is vertically inverted and the lower-tier foam 6c having a larger elastic modulus of rubber-like elasticity is located as the top surface.

The arrangement of FIG. 9(a) is arrangement when the breastbone of a normal adult is compressed, and the upper-tier foam 6b of the firm polyethylene foam having a smaller elastic modulus is combined with the lower-tier foam 6c of the soft polyolefin foam having a larger elastic modulus. When weight is applied from above by palms of hands with arms vertically extended, the lower tier is more contracted than the upper tier; however, although not to the extent of the lower tier, the upper tier itself is compressed while compressing the lower tier such that the feeling of depression of the actual adult breastbone can be acquired.

On the other hand, the arrangement of FIG. 9(b) is used for a practice of chest compression of a child's body, and the upper and lower tiers are inverted and interchanged from (a). In (b), the upper tier of the somewhat soft polyolefin foam having a larger elastic modulus is combined and arranged with the lower tier of the somewhat firm polyethylene foam having a smaller elastic modulus. When weight is applied from above by palms of hands with arms vertically extended, the somewhat soft polyolefin foam 6c having a larger elastic modulus of the upper tier is first compressed and, when the hardness similar to the lower-tier foam 6b is achieved, the lower-tier foam 6b starts to be compressed and, therefore, the degree of compression of the upper tier is increased.

Comparing the upper air chamber 7a of the opening hole in the center portion of the firm upper-tier foam 6b having a smaller elastic modulus and the lower air chamber 7b of the opening hole in the center portion of the soft lower-tier foam 6c having a larger elastic modulus of the pressing unit 6, the latter lower air chamber 7b has a larger diameter and, therefore, can more efficiently push out air at the time of compression. As a result, the wind pressure and air amount sufficient to generate the whistle sound can appropriately and sufficiently be acquired at the time of pressing, and balance is easily achieved between the hardness of pressing and the wind pressure and air amount of pushed-out air.

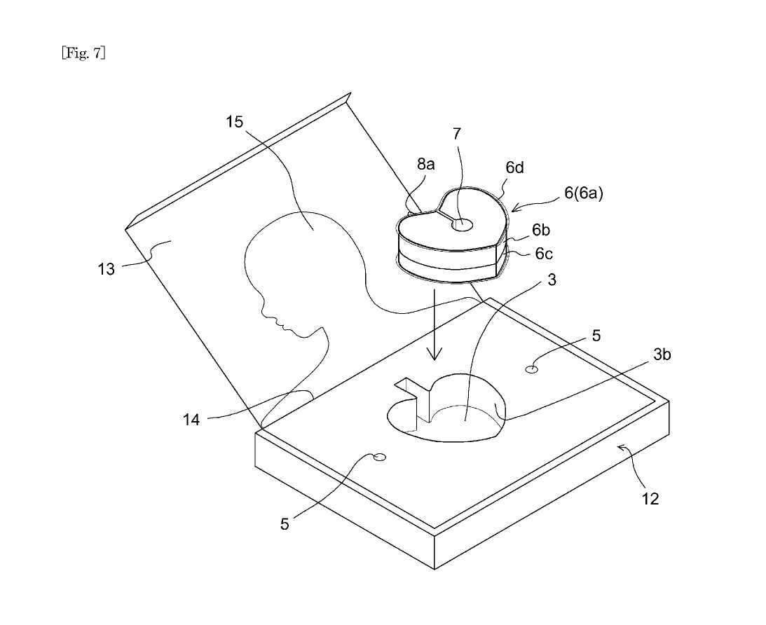

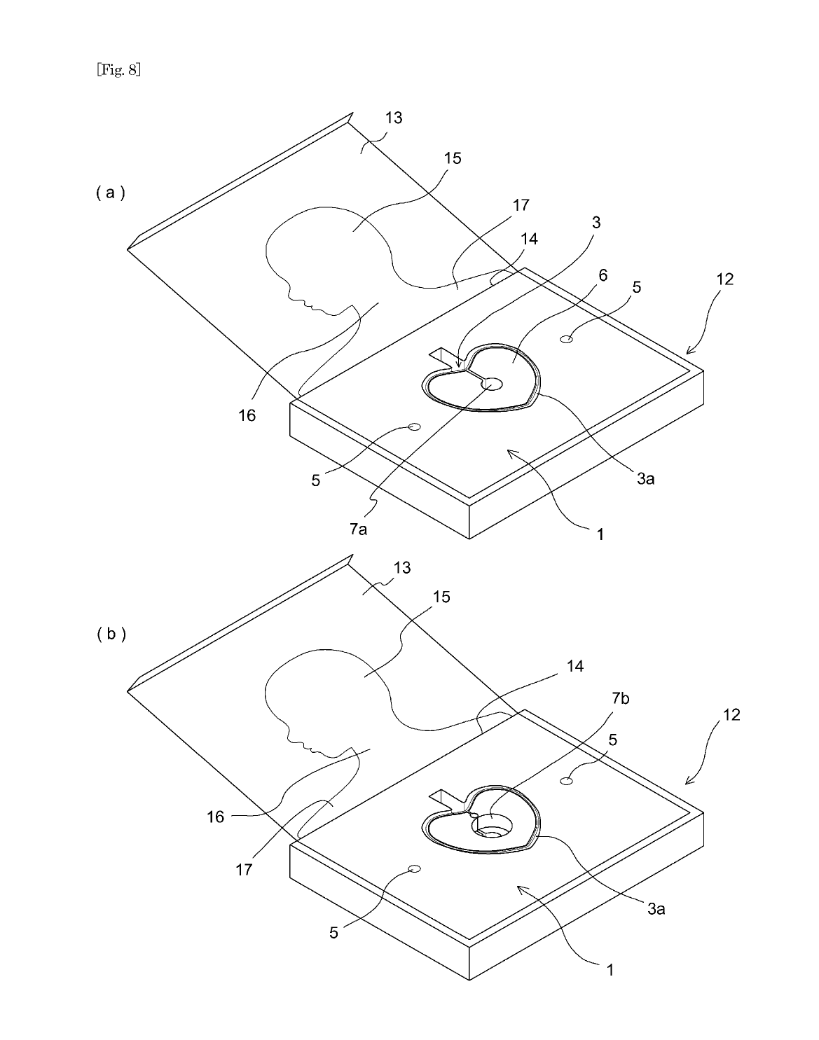

A third embodiment of the present invention will be described. In the embodiment of an aspect of the invention of claim 6, in addition to the first or second embodiment, the chest-mockup main unit 1 is made of a closed-cell synthetic resin foam colored in pale flesh. The palm-sized through-hole 3 opened in the center portion 2 of the chest-mockup main unit 1 is formed as the heart-shaped through-hole 3 depicted in FIG. 4(b) in this embodiment. Into the heart-shaped through-hole 3, the heart-shaped pressing unit 6 for cardiac massage practice as depicted in FIG. 5 made of the rubber-elastic closed-cell synthetic resin foam 6a consisting of a double-tier two-layer foam is fit into the palm-sized through-hole 3 as depicted in FIG. 7, for example. Although the heart-shaped pressing unit 6 for cardiac massage practice is made up of the upper-tier foam 6b and the lower-tier foam 6c stacked in two tiers as depicted in FIG. 5, these foams are colored differently from the chest-mockup main unit 1. In other words, the upper-tier foam 6b is colored in red-orange and the lower-tier foam 6c is colored in pink such that a difference in resilience of the rubber-like elasticity of the pressing unit 6 for cardiac massage practice is visually recognizable.

For example, between the two layers of the closed-cell synthetic resin foam 6a vertically stacked in two tiers, the rubber-like elastic closed-cell synthetic resin foam 6a of the upper layer is the upper-tier foam 6b made of a closed-cell polyethylene foam having three-fifths of the thickness of the chest-mockup main unit 1 and is colored in red-orange; the rubber-like elastic closed-cell synthetic resin foam 6a of the lower layer is the lower-tier foam 6c made of a closed-cell polyolefin foam having two-fifths of the thickness of the chest-mockup main unit 1 and is colored in pink; and, as a result, the two layers are configured such that when the orientation of the upper and lower layers of the pressing unit 6 for cardiac massage practice is inverted, a trainee can easily comprehend the orientation from the colors. The two vertically stacked layers of the closed-cell synthetic resin foam 6a have different elastic moduli of rubber-like elasticity and, therefore, the vertical inversion of the bag 6d of the pressing unit 6 for cardiac massage practice changes the feeling of hardness transmitted to the hands when pressing with the palm of the hand and, even if not pressing, which one is located upward or downward may visually be comprehended.

Additionally, since the two vertically stacked layers of the closed-cell synthetic resin foam 6a are differently colored by coloring the chest-mockup main unit 1 in pale flesh, even beginners can easily comprehend the position of the pressing unit 6 for cardiac massage practice and, since the double-stacked upper and lower tiers of the pressing unit 6 for cardiac massage practice are differently colored to enable visual recognition, even if the vertically stacked two-layer foam is vertically inverted, the difference in vertical orientation is easily visually recognizable based on the coloring. For example, in such a case that the practice is performed by a person with a weaker pressing force such as an elementary school student or a woman, even if the correct position is pressed, no sound may be emitted from the whistle 8a because of the weaker pressing force, and the educational effect may not sufficiently be acquired in terms of comprehension of the pressing position of chest compression. In this case, the vertical orientation can be checked by color to vertically invert the pressing unit 6 for cardiac massage practice to the orientation allowing a weaker pressing force to generate a sound and, therefore, the practice can be performed in the orientation allowing a weaker pressing force to generate a sound. As a result, the pressing of the pressing unit 6 for cardiac massage practice at a correct position can first be comprehended in a sensory manner. Therefore, the educational effect in the cardiac massage practice can be improved in terms of accurately learning the position recognition.

Subsequently, when the correct pressing position is comprehended, the vertical orientation of the double-tier foam is inverted again to the original vertical state based on the colors and, as a result, what degree of pressing force is actually required for the pressing unit 6 for cardiac massage practice can easily be comprehended by pressing until a sound of the whistle 8a is emitted, and such visual and auditory understandability enables more accurate comprehension.

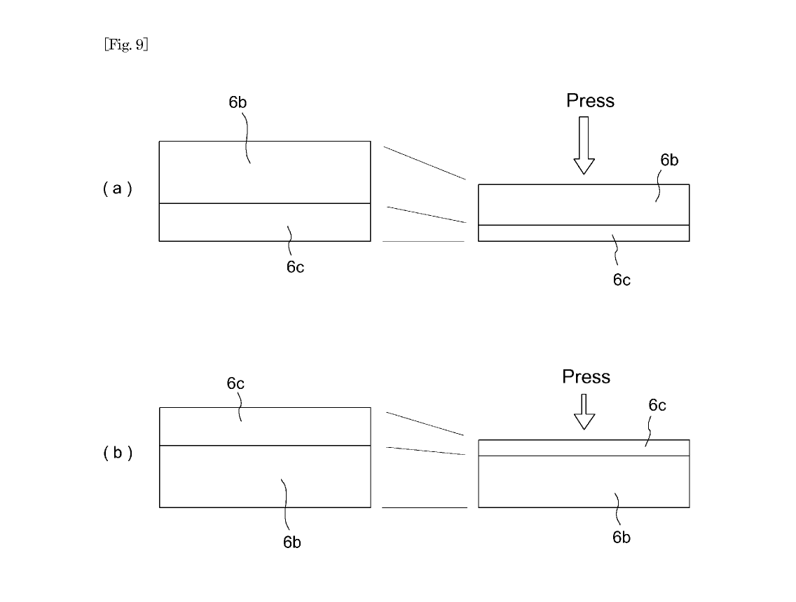

A fourth embodiment of the present invention will be described. The embodiment of an aspect of the invention of claim 7 is characterized in that the portable practical tool for cardiac massage in cardiopulmonary resuscitation described, for example, in the first to third embodiments is made up of a box 12 formed into a rectangular parallelepiped having a single-hinged lid 13 capable of housing the chest-mockup main unit 1 formed into a rectangular parallelepiped, as depicted in FIG. 6. The box 12 has a lid 12a of longitudinally 257 mm×laterally 334 mm×thickness 55 mm, for example. The single-hinged lid 12a is connected to one side-wall upper end 14 of the rectangular parallelepiped of the box 12. On the inner surface of the opened lid 12a, as depicted in FIG. 8, a head portion 15, a neck portion 16, and a shoulder portion 17 of a human model are drawn and linked to the chest-mockup main unit 1 in the box 12.

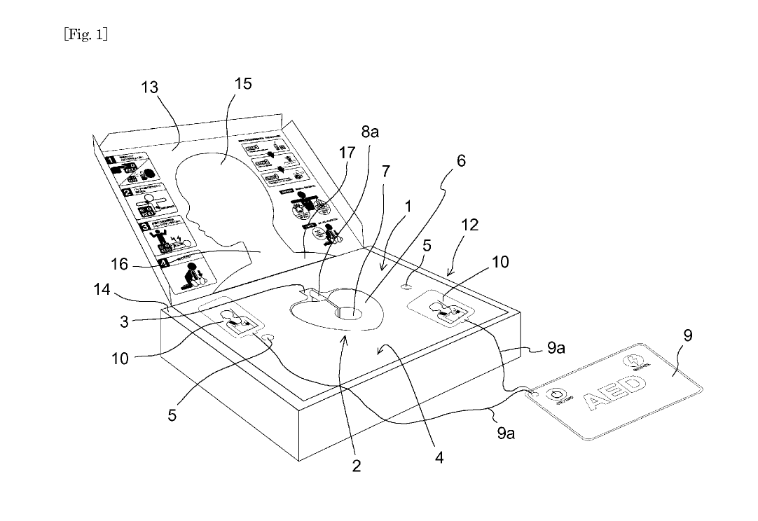

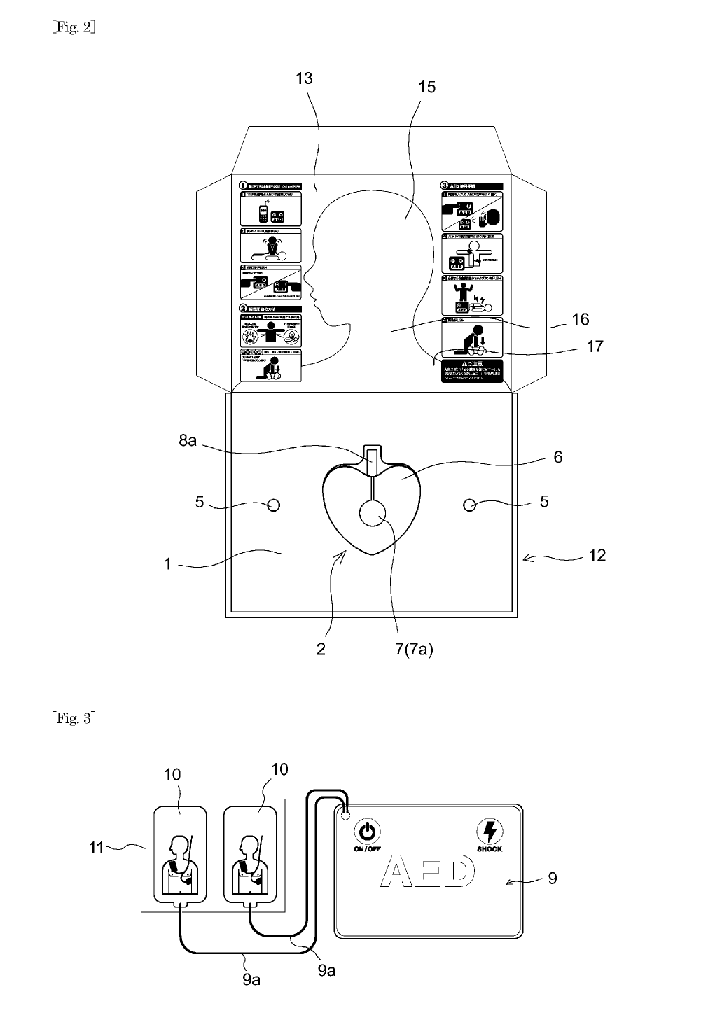

As described above, the practical tool for cardiac massage in cardiopulmonary resuscitation of the means of the present invention is integrally disposed with the box 12. Therefore, since this practical tool is of a portable type and the entire practical tool is compactly housed in the box 12, the practical tool is suitable for repeated use and a large number of the practical tools can easily be transported so that the devices can be lent to a multiplicity of trainees of cardiopulmonary resuscitation to perform the practice at one time. Since the practical tool has the head portion 15, the neck portion 16, and the shoulder portion 17 of the human model drawn on the inner surface 13 of the single-hinged lid, the upper side from the chest portion of the human model can immediately visually appear when the lid of the box is opened on a practice site, thereby realizing a cardiac massage practice with a higher sense of presence. As can be seen in FIGS. 1 and 2, the procedure of cardiac massage in cardiopulmonary resuscitation and the instructions of use of mock AED are naturally described on the both sides of the head portion 15, the neck portion 16, and the shoulder portion 17 of the human model drawn on the inner surface of the single-hinged lid 12a of the box 12. As a result, a preliminary lecture of cardiopulmonary resuscitation can be given before actual training and the practice can more appropriately be performed.

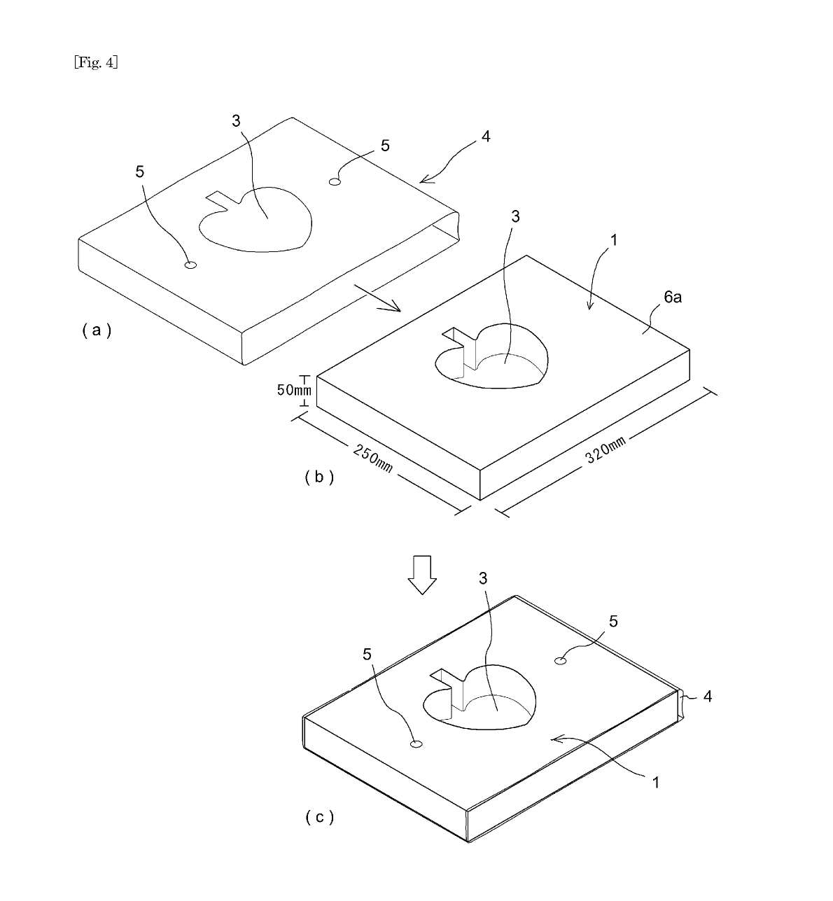

A fifth embodiment of the preset invention will be described. The embodiment of an aspect of the invention of claim 8 is the portable practical tool for cardiac massage in cardiopulmonary resuscitation of claim 4, wherein the portable practical tool for cardiac massage in cardiopulmonary resuscitation described in the first to fourth embodiments is disposed with a mock AED 9 imitating an operation surface shape of AED, i.e., automated external defibrillator, and mock electrode pads 10 in a pair made of synthetic resin sheets self-adhesive only on the back sides at ends of two codes 9a of about 50 cm long extended from the mock AED 9 as described in FIG. 3, and wherein these mock electrode pads 10 are detachably placed on the top surface of the synthetic resin film 4 covering the circumference of the rectangular parallelepiped of the chest-mockup main unit 1.

This mock AED 9 is made of a plate-shape sheet having a size of laterally 22 cm×longitudinally 15 cm and is covered with a transparent polyvinyl chloride sheet on the top and bottom surfaces; a 2-cm diameter ON/OFF switch is formed on the upper left of the top surface by drawing a white ring in a blue-colored portion somewhat raised schematically by doubling the polyvinyl chloride sheet; and a shock application button is also drawn on the upper right of the top surface as a white arrow representative of electric discharge in a 2-cm diameter brown-colored portion somewhat raised by doubling the polyvinyl chloride sheet.

The two cords 9a of about 50 cm long extended from the mock AED 9 are formed on the upper left of the top surface from tubes of 2-mm diameter flexible synthetic resin pipe; the mock electrode pads 10 made of synthetic resin sheets self-adhesive only on the back sides attached to the ends of the two codes 9a are flexible polyvinyl chloride sheets having a size of 5.5 cm×10.5 cm with a pearskin-finished non-adhesive top side; an upper body of a human model and the attachment positions of the mock electrode pads 10 on the upper body are schematically drawn on the top sides; and the back sides of the polyvinyl chloride sheet are formed self-adhesive to a smooth surface such as a polyvinyl chloride sheet made up of a smooth surface.

Imitating the actual electrode pad used after peeling off from a seal mount, the backsides of the mock electrode pads 10 are adherently fixed to a seal mount 11 made of flexible polyvinyl chloride by utilizing the self-adhesiveness. The mock electrode pads 10 are peeled off from the seal mount 11 and are attached to diagonal positions at an upper right chest portion (under the right collarbone to the right of the breastbone) and a lower left chest portion (5 to 8 cm under the left armpit) of a human body obliquely sandwiching the chest compression site (the heart) as depicted in FIG. 1. In so doing, guidance to the proper positions is given by following the illustration on the top sides of the electrode pads. It is important to closely attach the electrode pads to a human body and, since only the back sides are self-adhesive, if the electrode pads are wrongly attached, the electrode pads cannot be closely attached to the polyvinyl chloride sheet surface on the top side of the chest-mockup main unit 1 and, therefore, it can be recognized that the electrode pads have the top side and the bottoms side.

The self-adhesive sheet can easily be wiped when being soiled, and is therefore extremely excellent in handling and can repeatedly be used.

Since the portable practical tool for cardiac massage is disposed with the sheet of the mock AED 9 having the two mock electrode pads 10 in a pair, not only the cardiac massage practice but also a practice of the usage procedure of AED can extremely easily be performed by taking out the sheet of the mock AED 9 and the mock electrode pads 10 from the portable practical tool for cardiac massage.

### EXPLANATIONS OF REFERENCE NUMERALS

1 chest-mockup main unit
2 center portion of top and bottom surfaces of a chest-mockup main unit
3 palm-sized through-hole
3a gap
3b hole wall surface
4 synthetic resin film (polyvinyl chloride film)
5 nipple
6 pressing unit for cardiac massage practice
6a closed-cell synthetic resin foam
6b closed-cell synthetic resin foam
6c closed-cell synthetic resin foam
6d bag
7 air chamber
7a upper air chamber
7b lower air chamber
8 valve
8a whistle
8b opening
9 mock AED
9a cord
10 mock electrode pad
11 seal mount
12 box
12a lid
13 lid inner surface
14 one side-wall upper end
15 head portion
16 neck portion
17 shoulder portion

1. A portable practical tool for cardiac massage in cardiopulmonary resuscitation, the practical tool having a chest-mockup main unit (1) thicker than a thickness corresponding to a chest portion depression depth required for cardiac massage (sternal compression), the chest-mockup main unit (1) being made of foam synthetic resin, the chest-mockup main unit (1) having a palm-sized through-hole (3) imitating a size of a chest compression site from a top surface to a bottom surface in a center portion, the practical tool being disposed with a closed-cell synthetic resin foam (6a) that has an air chamber (7) inside contracted and returned in the top/bottom surface direction, the closed-cell synthetic resin foam (6a) being covered with a bag (6d) made of a synthetic resin film, the bag (6d) being disposed with a valve (8) in a side portion, the valve (8) being used both for entrance/exit of air in the air chamber (7) and for detection thereof, the closed-cell synthetic resin foam (6a) disposed with the air chamber (7) inside and covered with the bag (6d) being disposed in the through-hole (3) as a pressing unit (6) for cardiac massage practice, the practical tool having a gap (3a) between the through-hole (3) and the pressing unit (6) so as to allow free up-and-down movement of the pressing unit (6).

2. The portable practical tool for cardiac massage in cardiopulmonary resuscitation of claim 1, wherein the thickness corresponding to the chest portion depression depth required for cardiac massage (sternal compression) is 5 to 25 mm, and wherein the chest-mockup main unit (1) is made of a foam synthetic resin thicker than the thickness and having an outer shape of a rectangular parallelepiped.

3. The portable practical tool for cardiac massage in cardiopulmonary resuscitation of claim 1, wherein the top surface of the chest-mockup main unit (1) is covered with a synthetic resin film (4) except a portion of the top surface of the palm-sized through-hole.

4. The portable practical tool for cardiac massage in cardiopulmonary resuscitation of claim 1, wherein the closed-cell synthetic resin foam (6a) covered with the bag (6d) and having the air chamber (7) inside contracted and returned in the top/bottom surface direction is a double-tier two-layer foam, and wherein the foam is formed as the double-tier two-layer foam by stacking a rubber-like elastic closed-cell synthetic resin foam (6b) having an opening hole in the vertical direction in the center portion, and a rubber-like elastic closed-cell synthetic resin foam (6c) having a greater elastic modulus and a concentric opening hole with a diameter greater than the opening hole in a center portion.

5. The portable practical tool for cardiac massage in cardiopulmonary resuscitation of claim 1, wherein the valve (8) for air entrance/exit and air entrance/exit detection in the bag disposed on the side portion of the bag (6d) emits a sound depending on a wind pressure.

6. The portable practical tool for cardiac massage in cardiopulmonary resuscitation of claim 1, wherein the chest-mockup main unit (1) is made of a colored synthetic resin foam, and wherein the closed-cell synthetic resin foam (6a) covered with the bag (6d) and having the air chamber (7) inside contracted and returned in the top/bottom surface direction is made up of two layers of foam stacked in two tiers respectively colored differently from the chest-mockup main unit (1).

7. The portable practical tool for cardiac massage in cardiopulmonary resuscitation of claim 1, wherein the portable practical tool further has a box (12) including a single-hinged lid (12a) capable of housing the chest-mockup main unit (1), wherein the single-hinged lid (12a) of the box (12) is connected to one side-wall upper end (14) of the box (12) in a freely openable and closable manner, and wherein a head portion (15), a neck portion (16), and a shoulder portion (17) of a human model are drawn on an inner surface of the opened lid (12a) and linked to the chest-mockup main unit (1) housed in the box (12).

8. The portable practical tool for cardiac massage in cardiopulmonary resuscitation of claim 1, wherein the portable practical tool is disposed with a mock AED (9) imitating an operation surface shape of AED, i.e., automated external defibrillator, and two mock electrode pads (10) in a pair made of synthetic resin sheets self-adhesive only on the back sides at ends of two codes (9a, 9b) extended from the mock AED (9), and wherein the two mock electrode pads (10, 10) are detachably placed on the top surface of the synthetic resin film (4) covering the circumference of the rectangular parallelepiped of the chest-mockup main unit (1).
